(19) United States
(12) Patent Application Publication
(10) Pub. No.: US 2025/0173583 A1
(43) Pub. Date: May 29, 2025

(54) ANOMALY DETECTION, HANDLING, AND DATA COMPLIANCE RECORDATION FOR COMPLEX PROCESSING PREDICTION PIPELINES

(71) Applicant: Optum, Inc., Minnetonka, MN (US)

(72) Inventors: Andrew M. MOSSON, Dublin (IE); Vijayant KUMAR, Andover, MA (US)

(21) Appl. No.: 18/521,938

(22) Filed: Nov. 28, 2023

(51) Int. Cl. G06N 5/022

(52) U.S. Cl. CPC G06N 5/022

(57) ABSTRACT

Various embodiments of the present disclosure provide complex data processing pipeline configuration and anomaly detection techniques for developing, maintaining, and tracking metrics for time-based execution workflows. The techniques may include generating, using a current pipeline version of a data processing pipeline, a time-dependent output for a current data version of a dynamic input dataset at a current time and then generating a current compliance data object that is indicative of the current pipeline version, the current data version, and the time-dependent output to holistically record one or more aspect of the execution of the data processing pipeline. The techniques may include identifying a performance anomaly based on a comparison between the current compliance data object and a plurality of historical compliance data objects and initiating the performance of a predictive action based on the project segment.

### BACKGROUND

Various embodiments of the present disclosure address technical challenges related to the creation, management, and anomaly detection in complex data processing pipelines given limitations of traditional compliance and development computing environments. In traditional computing platforms, complex data processing pipelines that include multiple models, including machine learning models, may be executed to generate predictive results that are incapable of accurate replication due to various factors, such as modifications (i) to the processed dataset, (ii) to the configuration and/or parameters of the data processing pipeline, (iii) to the project configuration for executing the data processing pipeline and/or interpreting the predictive results of the pipeline, among other time dependent factors that are traditionally not tracked within a computing platform. The current inability to trace various aspects of a complex data processing pipeline lead to numerous technical disadvantages including, as some examples, limited capabilities for (i) replicating a project execution for auditing-among other purposes, (ii) detecting and tracking anomalous behavior of a data processing model, (iii) identifying particular sources of such behavior, (iv) tracking data trends in a time-dependent dataset, among other limitations. Various embodiments of the present disclosure make important contributions to existing model development and compliance platforms by addressing these technical challenges.

### BRIEF SUMMARY

Various embodiments of the present disclosure provide model development and tracking techniques for generating and leveraging comprehensive compliance data objects to holistically evaluate the execution of complex data processing pipelines over time. Specifically, a compliance data object may be generated that includes multiple project segments, each recording data specific to a particular aspect of the execution of a data processing pipeline. The compliance data object may be time dependent and may capture details, such as the current states of the pipeline, data, and/or the like, that are specific to a particular execution time of the data processing pipeline. A plurality of compliance data objects may be recorded over time and compared to generate predictive trends for a dataset, the pipeline, and/or the outputs thereof. These trends may be tracked to automatically detect and predict corrective actions for anomalies that may be caused by data defects, model defects, or may be attributable to real world changes in an environment. In this way, various techniques of the present disclosure improve complex model use and predictive capabilities by comprehensively recording various aspects of the execution of a data processing pipeline and using insights from previous model executions to drive, refine, and correct predictive actions as data, model, and outputs change over time. By doing so, some embodiments of the present disclosure provide improved techniques to overcome the technical challenges of conventional model development and compliance environments.

In some embodiment, a computer-implemented method includes generating, by one or more processors and using a current pipeline version of a data processing pipeline, a time-dependent output for a current data version of a dynamic input dataset at a current time; generating, by the one or more processors, a current compliance data object that is indicative of the current pipeline version, the current data version, and the time-dependent output; identifying, by the one or more processors, a performance anomaly based on a comparison between the current compliance data object and a plurality of historical compliance data objects, wherein the plurality of historical compliance data objects corresponds to a plurality of historical times temporally preceding the current time; identifying, by the one or more processors, a project segment corresponding to the performance anomaly, wherein the project segment is indicative of at least one of the current pipeline version, the current data version, or the time-dependent output; and initiating, by the one or more processors, the performance of a predictive action based on the project segment.

In some embodiments, a system includes a memory and one or more processors communicatively coupled to the memory, the one or more processors are configured to generate, using a current pipeline version of a data processing pipeline, a time-dependent output for a current data version of a dynamic input dataset at a current time; generate a current compliance data object that is indicative of the current pipeline version, the current data version, and the time-dependent output; identify a performance anomaly based on a comparison between the current compliance data object and a plurality of historical compliance data objects, wherein the plurality of historical compliance data objects corresponds to a plurality of historical times temporally preceding the current time; identify a project segment corresponding to the performance anomaly, wherein the project segment is indicative of at least one of the current pipeline version, the current data version, or the time-dependent output; and initiate the performance of a predictive action based on the project segment.

In some embodiments, one or more non-transitory computer-readable storage media include instructions that, when executed by one or more processors, cause the one or more processors to generate, using a current pipeline version of a data processing pipeline, a time-dependent output for a current data version of a dynamic input dataset at a current time; generate a current compliance data object that is indicative of the current pipeline version, the current data version, and the time-dependent output; identify a performance anomaly based on a comparison between the current compliance data object and a plurality of historical compliance data objects, wherein the plurality of historical compliance data objects corresponds to a plurality of historical times temporally preceding the current time; identify a project segment corresponding to the performance anomaly, wherein the project segment is indicative of at least one of the current pipeline version, the current data version, or the time-dependent output; and initiate the performance of a predictive action based on the project segment.

### BRIEF DESCRIPTION OF DRAWINGS

FIG. 1 illustrates an example computing system in accordance with one or more embodiments of the present disclosure.

FIG. 2 is a schematic diagram showing a system computing architecture in accordance with some embodiments discussed herein.

FIG. 3 is an example system diagram showing example systems in accordance with some embodiments discussed herein.

FIG. 4 is a dataflow diagram showing example data structures for facilitating an execution workflow project in accordance with some embodiments discussed herein.

FIG. 5 is a flowchart showing an example of a process for generating an execution workflow in accordance with some embodiments discussed herein.

FIG. 6 is an operational example of configuration interfaces in accordance with some embodiments discussed herein.

FIG. 7 is a flowchart showing an example of a process for executing an execution workflow in accordance with some embodiments discussed herein.

FIG. 8 is an operational example of an execution report interface in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that the present disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

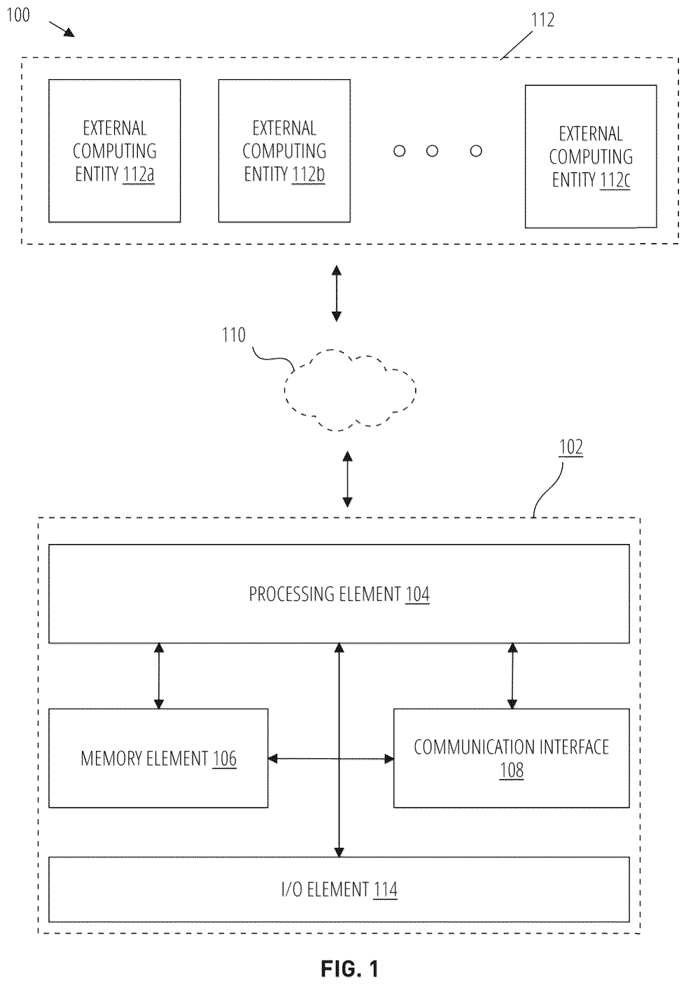

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., configuration techniques, evaluation techniques, development techniques, data management techniques, and/or the like) described herein.

The external computing entities 112a-c, for example, may include and/or be associated with one or more third-party computing resources that may be configured to receive, store, manage, and/or facilitate one or more portions of a machine learning based project. The third-party computing resources, for example, may be associated with one or more data repositories, cloud platforms, compute nodes, and/or the like, that may, in some circumstances, be leveraged by the predictive computing entity 102 to facilitate one or more stages of a machine learning based project.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

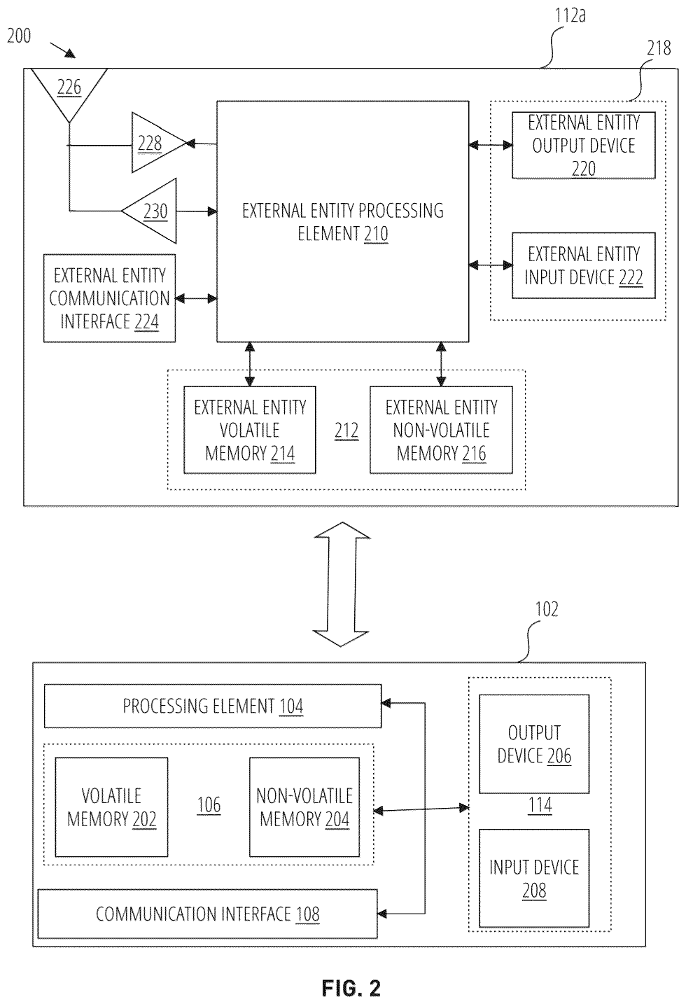

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more step/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established or fixed) or dynamic (e.g., created or modified at the time of execution).

The predictive computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. EXAMPLES OF CERTAIN TERMS

In some embodiments, the term “data processing pipeline” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The data processing pipeline may include a computing project configuration that defines a sequence of rules-based models, machine learning models, and/or operations for generating one or more predictive insights from a dataset. In some examples, the data processing pipeline may include a plurality of connected data processing models that are collectively (at least partially) configured to generate one or more predictive insights.

In some embodiments, the data processing pipeline includes an arrangement of a plurality of connected data processing models. The arrangement of the plurality of connected data processing models may define an order of execution for the plurality of models, such that outputs from one or more models may be input to one or more subsequent models within the arrangement. By way of example, the data processing pipeline may include a directed acyclic graph (DAG) with nodes identifying respective connected data processing models and the edges between the nodes identifying a flow of data and/or outputs between the models.

In some embodiments, the arrangement may be defined by pipeline configuration parameters. The pipeline configuration parameters, for example, may identify each of a plurality of connected data processing models and/or an order of execution for each of the plurality of connected data processing models. In some examples, the pipeline configuration parameters may include a DAG record that defines a plurality of nodes and edges between the nodes to generate a DAG of connected data processing models. By way of example, the DAG record may define a connected data processing model as a node with one or more pointers referencing other nodes (e.g., neighboring data processing model) for receiving inputs from and/or providing output to.

In some embodiments, the term “connected data processing model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). In some examples, the connected data processing model may include a machine learning model that is configured, trained, and/or the like to generate a predictive and/or classification output for an input dataset. The connected data processing model may include one or more of any type of machine learning model including one or more supervised, unsupervised, semi-supervised, reinforcement learning models, and/or the like. In addition, or alternatively, the connected data processing model may include one or more statistical models, causal effect models, and/or any other rules-based models.

In some embodiments, the term “compliance data object” refers to a data entity that describes an instance of an execution workflow at a particular point in time. A compliance data object, for example, may include a plurality of project segments, each indicative of one or more aspects of a workflow instance for an execution workflow at a particular point in time. For example, a workflow instance may include the execution of the data processing pipeline on a dynamic input dataset to generate a time-dependent output at a particular point in time. The compliance data object may include a model project segment indicative of the data processing pipeline at the particular point in time, a data project segment indicative of the dynamic input dataset at the particular point in time, and/or an output project segment indicative of the time-dependent output at the particular point in time. Each of the plurality of project segments may include version information for a respective aspect of the workflow instance as well as metadata sufficient to re-execute the execution workflow to receive the same time-dependent output at a future time subsequent to the particular period of time at which the workflow instance is initially executed.

In some embodiments, each project segment is indicative of a version and metadata for a particular aspect of the workflow instance. For example, a model project segment may be indicative of a pipeline version and/or pipeline metadata for the pipeline version. The pipeline metadata, for example, may be indicative of one or more execution anomalies (e.g., execution success/failure of one or more connected data processing models, etc.) related to the data processing pipeline, one or more execution metrics (e.g., time, processing power, etc.), one or more users (e.g., owners, developers, etc.), and/or the like. As another example, the data project segment may be indicative of a data version and/or dataset meta data for the data version of the dataset. The dataset metadata, for example, may be indicative of data configuration data (e.g., data sources, data structures, etc.) for the input dataset, one or more updates (e.g., update frequency, rate, extent, etc.) to the input dataset, one or more data anomalies (e.g., missing data exception, unbalanced dataset exceptions, etc.) related to the input dataset, one or more data metrics (e.g., data quality metrics, size metrics, bias metrics, etc.) for the input dataset, and/or the like. As yet another example, the output project segment may include one or more output values corresponding to a pipeline version of a data processing pipeline and a data version of an input dataset at a particular point in time. In some examples, the output project segment may include project metadata that is indicative of one or more post processing thresholds (e.g., classification thresholds for classifying one or more objects of interest in data, etc.), one or more project anomalies (e.g., trends, output outliers, etc. based on previous workflow instances, etc.), and/or the like. By way of example, the output project segment may be indicative of a holistic time-dependent output from the data processing pipeline at a particular point in time.

In some embodiments, the term “pipeline version” refers to a data entity that describes the configuration of a data processing pipeline at a particular point in time. A pipeline version, for example, may include pipeline configuration data for the data processing pipeline and/or each of the connected data processing models of the data processing pipeline. For example, the pipeline configuration data may be indicative of an arrangement of the connected data processing models (e.g., DAG record, etc.) at the particular point in time. In addition, or alternatively, the pipeline configuration data may be indicative of one or more updates to the arrangement of the connected data processing models. In some examples, the pipeline configuration data may be indicative of a model version for each of the plurality of connected data processing models. The model version, for example, may define a particular version of software code, and/or the like. In addition, or alternative, the pipeline configuration data may be indicative of one or more weighted parameters (e.g., trained parameters for machine learning models, etc.) for one or more of the connected data processing models. By way of example, the pipeline configuration data may be indicative of a set of weighted parameters for each of the connected data processing models of the data processing pipeline at a particular point in time.

In some embodiments, the term “dynamic input dataset” refers to a data entity that describes a plurality of time-dependent data objects for a particular prediction domain. For example, the dynamic input dataset may fluctuate over time and include time-dependent data objects that may be modified, added, removed, and/or like from the dynamic input dataset over one or more time periods. For instance, the dynamic input dataset may include an aggregated dataset of time-dependent data objects that are continuously received by a plurality of disparate datasets. The dynamic input dataset may include any type of dataset configured to receive, store, and/or arrange a plurality of data objects and/or attributes thereof. In some examples, the dynamic input dataset (and/or the time-dependent data objects thereof) may be based on a prediction domain. For instance, in a clinical prediction domain, the time-dependent data objects may include medical claims issued, received, and performed at a particular point in time. In such a case, the dynamic input dataset may include a plurality of medical claims that may be removed (e.g., as outdated), modified (e.g., to correct recordation errors, etc.), and/or added as new medical claims are issued over time.

In some embodiments, a dynamic input dataset includes a dataset of time-dependent data objects that achieve one or more dataset parameters for an execution workflow. For example, the dataset parameters may define a portion of a dataset, such as a population cohort, on which to execute a data processing pipeline. In a clinical prediction domain, for example, the dynamic input dataset may include a portion of a population that defines a population of interest.

In some embodiments, the term “dataset parameters” refers to a data entity that describes one or more criteria for generating a dynamic input dataset. The dataset parameters may be configured for an execution workflow to define a dataset of time-dependent data objects for analysis. The dataset parameters, for example, may identify one or more attributes of interest for time-dependent data objects within the dynamic input dataset. For instance, the attributes of interest may include one or more temporal attributes (e.g., time attributes within a time period, etc.), classification attributes (e.g., clinical classifications, etc.), individual attributes (e.g., age, demographics, etc. for an individual associated with a time-dependent data object), and/or the like that may differentiate a plurality of time-dependent data objects for particular use cases.

The dataset parameters may be based on the prediction domain and/or the projection execution. In some examples, for a clinical prediction domain, the dataset parameters may define a population of interest and the dynamic input dataset may include medical claims for a plurality of individuals within the population of interest. By way of example, the population of individuals may include individuals that have been diagnosed with a disease of interest in a disease progression use case, and/or the like. In other examples, the population of individuals may include individuals within a certain age group for an age-based population analysis use case, and/or the like. As will be understood, the techniques of the present disclosure may define any number of a plurality of different dynamic input datasets using dataset parameters tailored to any use case.

In some embodiments, the term “time-dependent data object” refers to a data entity that describes a data object within a dynamic input dataset. In some examples, the time-dependent data object may include an individual data unit that may be individually (and/or collectively) input to a data processing pipeline to receive a predictive and/or classification output for an execution workflow. A time-dependent data object may include a plurality of object attributes that describe one or more characteristics of the time-dependent data object. The one or more object attributes may include a temporal attribute that identifies a particular time (e.g., a time stamp, etc.) corresponding to the time-dependent data object. As described herein, the relevance (e.g., time-based priority, etc.) for a time-dependent data object with respect to an execution of the execution workflow may be based on the temporal attribute.

A time-dependent data object may include any type of data object and, in some examples, may depend on the prediction domain. As one example, in a clinical prediction domain, the time-dependent data object may include a medical claim from a member of a population of interest. The medical claim may correspond to a particular point in time at which the claim was issued, a procedure referenced by the claim was performed, and/or the like. In such a case, the medical claim may include a temporal attribute that identifies an issue time of the claim, a performance time of a medical procedure, and/or the like.

In some embodiments, the term “object attribute” refers to a data entity that describes a characteristic of a time-dependent data object. An object attribute may include any number of different attributes for describing various characteristics of the time-dependent data object. As examples, an object attribute may include a temporal attribute (e.g., time stamp, etc.) and/or one or more predictive attributes that may be analyzed, using the data processing pipeline, to generate one or more predictive outputs. The predictive attributes may depend on the prediction domain. In one example, for a clinical prediction domain,

In some embodiments, the term “time-based priority” refers to a data entity that describes a relevance of a time-dependent data object for an instance of an execution workflow. A time-based priority may correspond to a particular time-dependent data object. For example, a time-based priority may be generated, identified, and/or otherwise accessed for one or more time-dependent data objects of a dynamic input dataset based on the respective object attributes for the time-dependent data objects. The time-based priority may identify a relative priority for each of the time-dependent data objects during a workflow instance. In some examples, the time-based priority may include an additional feature that is considered by one or more of the plurality of connected data processing models of the data processing pipeline.

In some embodiments, the time-based priority for a time-dependent data object is based on a comparison between one or more priority criteria and/or one or more object attributes of the time-dependent data object. For example, the one or more priority criteria may be defined by one or more prioritization parameters to prioritize one or more data objects with respect to their object attributes. The prioritization parameters, for example, may define a time priority scheme configured to assign a higher priority to newer data objects relative to older data objects. As another example, the prioritization parameters may define a demographic priority scheme configured to assign higher priority to data objects associated with an underrepresented demographic relative to an overrepresented demographic.

The prioritization parameters may be based on the prediction domain and/or one or more goals for an execution workflow. For instance, in a clinical prediction domain, the prioritization parameters may prioritize newer data objects relative to older data objects to emphasize temporal trends in a disease progression use case. As another example, the prioritization parameters may prioritize data objects associated with an underrepresented demographic relative to an overrepresented demographic to balance a dataset for a population analysis use case.

In some embodiments, the term “data version” refers to a data entity that describes the configuration of a dynamic input dataset at a particular point in time. For example, a data version may include state data for the dynamic input dataset. The state data may be indicative of a particular version of the dataset that identifies the time-dependent data objects within the dynamic input dataset at a particular point in time. In addition, or alternatively, the state data may identify one or more time-based priorities, one or more updates, and/or the like for each of the time-dependent data objects of the dynamic input dataset at a particular point in time. In some examples, the time-dependent data objects of the dynamic input dataset at a particular point in time may include a plurality of data objects associated with a temporal attribute that is within a time window ending, beginning, and/or surrounding the particular point in time. In such a case, the state data for the dynamic input dataset may identify the time-dependent data objects (and/or the time-based priority, etc. thereof) that are associated with a temporal attribute that falls within the time window.

In some embodiments, the term “performance anomaly” refers to a data entity that describes an anomalous output from the workflow instance. The anomalous output may be based on a comparison between a time-dependent output from a workflow instance and a plurality of historical workflow instances. For example, the performance anomaly may be indicative of one or more outlier time-dependent outputs relative to historical outputs from the data processing pipeline.

In some embodiments, the term “model-based anomaly” refers to a data entity that describes a predictive contributor to a performance anomaly. A model-based anomaly, for example, may be a prediction that the data processing pipeline contributed to the performance anomaly. By way of example, the model-based anomaly may be indicative of one or more predictive model errors (e.g., development, runtime, etc.), modifications, and/or the like, that have a predictive impact on the time-dependent outputs of the data processing pipeline.

In some embodiments, the term “data-based anomaly” refers to a data entity that describes a predictive contributor to a performance anomaly. A data-based anomaly, for example, may include a prediction that the dynamic input dataset contributed to the performance anomaly. By way of example, the data-based anomaly may be indicative of one or more predictive data errors (e.g., aggregation errors, data query errors, incomplete data entries, etc.), modifications, and/or the like, that have a predictive impact on the time-dependent outputs of the data processing model.

In some embodiments, the term “predictive action” refers to a data entity that describes an action for responding to a performance anomaly. A predictive action may include a corrective action and/or an alerting action. For instance, a corrective action may include one or more predictive corrections for modifying the data processing pipeline and/or the dynamic input dataset to correct a model-based and/or data-based anomaly. As another example, an alerting action may include generating and/or providing one or more predictive alert messages to one or more computing systems (and/or users thereof) to record and/or notify a recipient of the message.

### IV. OVERVIEW, TECHNICAL IMPROVEMENTS, AND TECHNICAL ADVANTAGES

Embodiments of the present disclosure present model configuration and monitoring techniques that provide improvements over traditional development and runtime infrastructures. The model configuration and monitoring techniques may be leveraged to develop and monitor complex data processing models through various executions over time. Granular details of each execution of the developed model may be maintained in comprehensive compliance records. Unlike conventional versioning techniques, the compliance records include information for each segment of a project, including the input data, the model data, and output data, for a particular execution of a developed model. This enables the accurate replication of a previous execution despite continuous changes to the input data, the model, and the outputs from the model over time. Embodiments of the present disclosure provide various improvements over traditional computing environments by enabling the generation of holistic compliance records and then leveraging the compliance records to handle various aspects of a complex data processing model.

In some embodiments, the present disclosure provides improved techniques for configuring and executing a holistic execution workflow that accounts for time-based input data, complex data processing pipelines, and predictive outputs. The execution workflow, for example, may include parameters that define a dynamic input dataset, a data processing pipeline, and desired outputs from the data processing pipeline. These parameters may be leveraged, at runtime, to generate time-specific instances of a dynamic dataset and a data processing pipeline for generating time-dependent outputs. In this way, an end-to-end workflow may be configured to generate time-specific outputs that account for changes to every aspect of a project. This, in turn, allows for greater flexibility in model design and modifications to models, data, and/or any other aspect of an execution workflow, without compromising the predictive outputs thereof.

In some embodiments, the present disclosure provides improved techniques for anomaly detection and tracking for complex data processing pipelines. To do so, some of the techniques of the present disclosure leverage comprehensive compliance data objects to monitor various aspects of an execution workflow over time. A compliance data object may be generated to record each aspect of an execution of an execution workflow at a particular time. In this manner, a plurality of compliance data objects may be generated over time to track the contextualized performance of a complex data processing pipeline. Using the compliance data objects, the contextualized performance of the data processing pipeline may be monitored to detect anomalous behavior and, in the event of anomalous behavior, various aspects of the execution workflow may be analyzed to detect the source of the anomaly. In this way, unlike traditional model monitoring techniques, the techniques of the present disclosure enable the detection of the source of a performance anomaly. This, in turn, improves the interpretation of model outputs, while enabling improved model performance through targeted updates to the parameters of a data processing pipeline, a dynamic input dataset, or any other aspect of a holistic execution workflow.

Example inventive and technologically advantageous embodiments of the present disclosure include (i) techniques for developing and tracking complex data processing pipelines, (ii) user-facing workflows implementing said techniques, (iii) anomaly detection and tracking techniques for monitoring the performance and/or predictive output of complex data processing models, among others.

### V. EXAMPLE SYSTEM OPERATIONS

As indicated, various embodiments of the present disclosure make important technical contributions to model development, monitoring, and anomaly detection computing environments. In particular, systems and methods are disclosed herein that implement data processing pipeline configuration and execution techniques for seamlessly configuring an end-to-end execution workflow that dynamically adjusts over time and recording comprehensive compliance data objects to track workflow parameters and performance as the workflow is executed. These techniques are leveraged to improve the detection and interpretation of workflow anomalies in complex data processing computing operations.

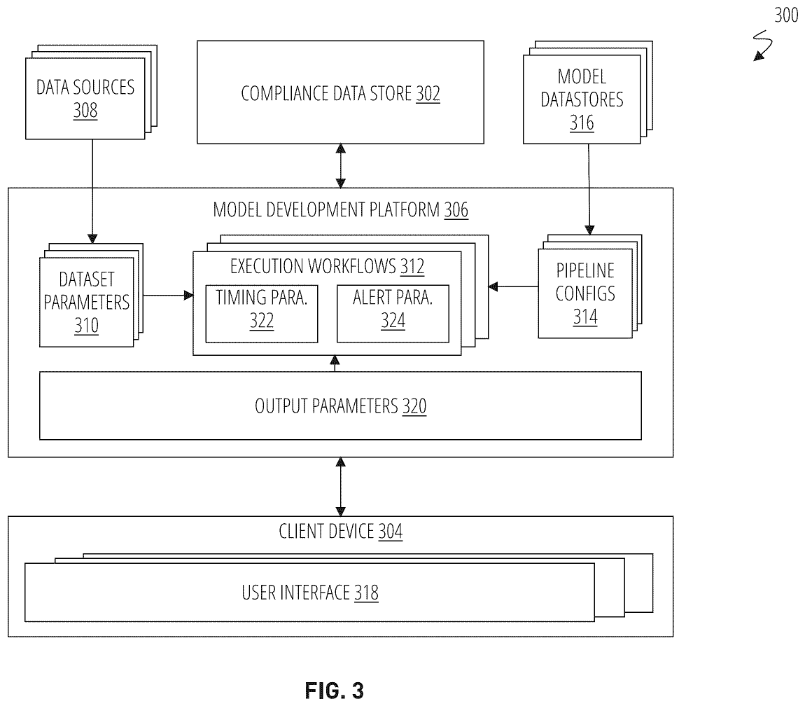

FIG. 3 is an example system diagram 300 showing example systems in accordance with some embodiments discussed herein. The system diagram 300 depicts computing entities for configuring and maintaining a holistic execution workflows 312, each involving one or more data processing pipelines from one or more model datastores 316, datasets stored and/or aggregated from one or more data sources 308, and/or execution parameters defining one or more execution characteristics of the execution workflows 312.

The system diagram 300 depicts a model development platform 306 and one or more internal and/or external computing components including a client device 304, one or more data sources 308, compliance datastore 302, and model datastores 316. In some examples, the model development platform 306 may include an embodiment of the predictive computing entity 102 and may include one or more components described herein with respect to the predictive computing entity 102. In some examples, the data sources 308, compliance datastore 302, model datastores 316, and/or client device 304 may include one or more computing components of the model development platform 306. In addition, or alternatively, one or more of the data sources 308, compliance datastore 302, model datastores 316, and/or client device 304 may be external to the model development platform 306. By way of example, each of the data sources 308, compliance datastore 302, model datastores 316, and/or client device 304 may include embodiments of the external computing entities 112a-c and may include one or more components described herein with respect to the external computing entities 112a-c.

In some embodiments, the client device 304 includes an external computing entity that is configured to interact with the model development platform 306 to generate, maintain, manage, track, and/or the like an execution workflow. An execution workflow, for example, may include a user-defined project workflow. The client device 304 may be operated by various entities and/or may be associated with, owned by, operated by, and/or the like by one or more end users that may interact with the model development platform 306 to configure the user-defined project workflow. For example, a client device 304 may be a personal computing device, smartphone, tablet, laptop, personal digital assistant, and/or the like. In some examples, the one or more end users of a client device 304 may generate, maintain, manage, track, and/or the like an execution workflow by leveraging one or functionalities provided by model development platform 306 through user input with the client device 304. By way of example, the client device 304 may include one or more user interfaces 318 (e.g., external I/O elements, etc.) that may be a configured to provide one or more application screens presented by one or more computing platforms, such as the model development platform 306. Each of the user interfaces 318, for example, may be configured to present data indicative of an execution workflow (e.g., configuration data, etc.) and/or receive user input indicative of one or more parameters for an execution workflow, among other inputs.

In some embodiments, the model development platform 306 is configured to generate and/or maintain a plurality of execution workflows 312. An execution workflow may include a data analysis project for a predictive domain that may be defined and then executed at an execution frequency. For example, an execution workflow may be configured to execute one or more data processing pipelines with respect to one or more dynamic input datasets at a defined frequency to generate one or more time-dependent outputs. Each of the aspects of an execution workflow may be defined during the configuration of the execution workflow. In some examples, each aspect may be time-dependent such that the one or more data processing pipelines, the one or more dynamic input datasets, and/or the one or more time-dependent outputs may dynamically change through coding updates, parameter modifications, data updates, and/or the like, over time. In some examples, the model development platform 306 may be configured to generate compliance data objects representative of each execution of the execution workflow to monitor, track, and investigate changes to execution workflow (and/or aspects thereof) over time.

In some embodiments, an execution workflow is defined by a plurality of workflow parameters that identify one or more aspects of the execution workflow. During configuration, an execution workflow may be generated by setting one or more of the plurality of workflow parameters. For example, the model development platform 306 may facilitate an execution workflow configuration process during which a user is guided through one or more user interfaces to select, access, and/or otherwise establish one or more of the workflow parameters. The workflow parameters, for example, may include one or more dataset parameters 310, one or more pipeline configuration parameters 314, one or more output parameters 320, one or more timing parameters 322, one or more alert parameters 324, and/or the like. In some examples, the configuration process may include one or more user interfaces tailored to one or more of the above examples.

In some embodiments, an execution workflow includes dataset parameters 310 that define one or more datasets of the execution workflow. The dataset parameters 310, for example, may define and/or identify at least one dynamic input dataset for an execution workflow. In some examples, the dataset parameters 310 may include one or more predetermined dataset parameters corresponding to a predefined dynamic input dataset. For instance, the dataset parameters 310 for an execution workflow may be selected from a list of predetermined dataset parameters. In addition, or alternatively, the dataset parameters 310 may be generated to define a dynamic input dataset tailored to a particular execution workflow.

In some embodiments, a dynamic input dataset is a data entity that describes a plurality of time-dependent data objects for a particular prediction domain. For example, the dynamic input dataset may fluctuate over time and include time-dependent data objects that may be modified, added, removed, and/or like from the dynamic input dataset over one or more time periods. For instance, the dynamic input dataset may include an aggregated dataset of time-dependent data objects that are continuously received by a plurality of disparate data sources 308. The dynamic input dataset may include any type of dataset configured to receive, store, and/or arrange a plurality of data objects and/or attributes thereof. In some examples, the dynamic input dataset (and/or the time-dependent data objects thereof) may be based on a prediction domain. For instance, in a clinical prediction domain, the time-dependent data objects may include medical claims issued, received, and performed at a particular point in time. In such a case, the dynamic input dataset may include a plurality of medical claims that may be removed (e.g., as outdated), modified (e.g., to correct recordation errors, etc.), and/or added as new medical claims are issued over time.

In some embodiments, a dynamic input dataset includes a dataset of time-dependent data objects that achieve the one or more dataset parameters 310 for an execution workflow. For example, the dataset parameters 310 may define a portion of one or more datasets, such as a population cohort, on which to execute a data processing pipeline. In a clinical prediction domain, for example, a dynamic input dataset may include a portion of a population that defines a population of interest.

In some embodiments, the dataset parameters 310 are a data entity that describes one or more criteria for generating a dynamic input dataset for an execution workflow. The dataset parameters may be pre-configured and/or dynamically configured for an execution workflow to define a dataset of time-dependent data objects for analysis. The dataset parameters, for example, may identify one or more attributes of interest for time-dependent data objects within the dynamic input dataset. For instance, the attributes of interest may include one or more temporal attributes (e.g., time attributes within a time period, etc.), classification attributes (e.g., clinical classifications, etc.), individual attributes (e.g., age, demographics, etc. for an individual associated with a time-dependent data object), and/or the like, that may differentiate a plurality of time-dependent data objects for particular use cases.

The dataset parameters 310 may be based on the prediction domain and/or the projection execution. In some examples, for a clinical prediction domain, the dataset parameters 310 may define a population of interest and the dynamic input dataset may include medical claims for a plurality of individuals within the population of interest. By way of example, the population of individuals may include individuals that have been diagnosed with a disease of interest in a disease progression use case, and/or the like. In other examples, the population of individuals may include individuals within a certain age group for an age-based population analysis use case, and/or the like. As will be understood, the techniques of the present disclosure may define any number of a plurality of different dynamic input datasets using dataset parameters 310 tailored to any use case.

In some embodiments, a time-dependent data object is a data entity that describes a data object within a dynamic input dataset. In some examples, the time-dependent data object may include an individual data unit that may be individually (and/or collectively) input to a data processing pipeline to receive a predictive and/or classification output for an execution workflow. A time-dependent data object may include a plurality of object attributes that describe one or more characteristics of the time-dependent data object. The one or more object attributes may include a temporal attribute that identifies a particular time (e.g., a time stamp, etc.) corresponding to the time-dependent data object. As described herein, the relevance (e.g., time-based priority, etc.) for a time-dependent data object with respect to an execution of the execution workflow may be based on the temporal attribute.

A time-dependent data object may include any type of data object and, in some examples, may depend on the prediction domain. As one example, in a clinical prediction domain, a time-dependent data object may include a medical claim from a member of a population of interest. The medical claim may correspond to a particular point in time at which the claim was issued, a procedure referenced by the claim was performed, and/or the like. In such a case, the medical claim may include a temporal attribute that identifies an issue time of the claim, a performance time of a medical procedure, and/or the like.

In some embodiments, an object attribute is a data entity that describes a characteristic of a time-dependent data object. An object attribute may include any number of different attributes for describing various characteristics of the time-dependent data object. As examples, an object attribute may include a temporal attribute (e.g., time stamp, etc.) and/or one or more predictive attributes that may be analyzed, using a data processing pipeline, to generate one or more predictive outputs. The predictive attributes may depend on the prediction domain. In one example, for a clinical prediction domain, the predictive attributes may include a number of admissions, one or more disease classifications, one or more diagnoses, and/or the like.

In some embodiments, the object attributes for a time-dependent data object are aggregated from across the plurality of disparate data sources 308 in accordance with the dataset parameters 310.

In some embodiments, the time-based priority is a data entity that describes a relevance of a time-dependent data object for an instance of an execution workflow. A time-based priority may correspond to a particular time-dependent data object. For example, a time-based priority may be generated, identified, and/or otherwise accessed for one or more time-dependent data objects of a dynamic input dataset based on the respective object attributes for the time-dependent data objects. The time-based priority may identify a relative priority for each of the time-dependent data objects during an instance of an execution workflow. In some examples, the time-based priority may include an additional feature that is considered by one or more of the plurality of connected data processing models of the data processing pipeline.

In some embodiments, the time-based priority for a time-dependent data object is based on a comparison between one or more priority criteria and/or one or more object attributes of the time-dependent data object. For example, the workflow parameters may include one or more prioritization parameters that define one or more priority criteria to prioritize one or more data objects with respect to their object attributes. The prioritization parameters, for example, may define a time priority scheme for assigning a higher priority to newer data objects relative to older data objects. As another example, the prioritization parameters may define a demographic priority scheme for assigning higher priority to data objects associated with an underrepresented demographic relative to an overrepresented demographic.

The prioritization parameters may be based on the predictive domain and/or one or more goals for an execution workflow. For instance, in a clinical prediction domain, the prioritization parameters may prioritize newer data objects relative to older data objects to emphasize temporal trends in a disease progression use case. As another example, the prioritization parameters may prioritize data objects associated with an underrepresented demographic relative to an overrepresented demographic to balance a dataset for a population analysis use case.

In some embodiments, the execution workflow includes pipeline configuration parameters 314 that define one or more data processing pipelines of the execution workflow. The pipeline configuration parameters 314, for example, may define and/or identify at least one data processing pipeline for an execution workflow. In some examples, the pipeline configuration parameters 314 may include one or more predetermined pipeline configuration parameters corresponding to a predefined data processing pipeline. For instance, the pipeline configuration parameters 314 for an execution workflow may be selected from a list of predetermined pipeline configuration parameters, each respectively identifying a predefined data processing pipeline. In addition, or alternatively, the pipeline configuration parameters 314 may be generated to define a data processing pipeline tailored to a particular execution workflow.

In some embodiments, a data processing pipeline is a data entity that describes parameters, hyper-parameters, and/or defined operations of a rules-based and/or machine learning model (e.g., model including at least one of one or more rule-based layers, one or more layers that depend on trained parameters, coefficients, and/or the like). The data processing pipeline may include a computing project configuration that defines a sequence of rules-based models, machine learning models, and/or operations for generating one or more predictive insights from a dataset, such as a dynamic input dataset defined for a particular execution workflow. In some examples, the data processing pipeline may include a plurality of connected data processing models that are collectively (at least partially) configured to generate one or more predictive insights.

In some embodiments, the data processing pipeline includes an arrangement of a plurality of connected data processing models. The arrangement of the plurality of connected data processing models may define an order of execution for the plurality of models, such that outputs from one or more models may be input to one or more subsequent models within the arrangement. By way of example, the data processing pipeline may include a directed acyclic graph (DAG) with nodes identifying respective connected data processing models and the edges between the nodes identifying a flow of data and/or outputs between the models.

In some embodiments, the arrangement may be defined by the pipeline configuration parameters 314. The pipeline configuration parameters 314, for example, may identify each of a plurality of connected data processing models and/or an order of execution for each of the plurality of connected data processing models. In some examples, the pipeline configuration parameters 314 may include a DAG record that defines a plurality of nodes and edges between the nodes to generate a DAG of connected data processing models. By way of example, the DAG record may define a connected data processing model as a node with one or more pointers referencing other nodes (e.g., neighboring data processing model) for receiving inputs from and/or providing output to. In this manner, the pipeline configuration parameters 314 may define an end-to-end data processing pipeline in which a dataset is processed, sequentially and/or in parallel, by a plurality of connected data processing models. Outputs from each model may be included as inputs to a subsequent connected model to generate complex predictions built upon multiple collaborative algorithms.

In some embodiments, a connected data processing model is a data entity that describes parameters, hyper-parameters, and/or defined operations of a rules-based and/or machine learning model (e.g., model including at least one of one or more rule-based layers, one or more layers that depend on trained parameters, coefficients, and/or the like). In some examples, a connected data processing model may include a machine learning model that is configured, trained, and/or the like to generate a predictive and/or classification output for an input dataset (and/or one or more data object therein). The connected data processing model may include one or more of any type of machine learning model including one or more supervised, unsupervised, semi-supervised, reinforcement learning models, and/or the like. In addition, or alternatively, the connected data processing model may include one or more statistical models, causal effect models, and/or any other rules-based models.

In some embodiments, the connected data processing models are stored, developed, and/or executed through one or more model datastores 316. By way of example, the one or more model datastores 316 may include one or more external and/or internal computing platforms configured to host and/or otherwise provide access to one or more machine learning models, rules-based models, and/or the like that may be leveraged by an execution workflow.

In some examples, the pipeline configuration parameters 314 may include a plurality of references (e.g., application programming interface (API) calls, etc.) to one or more connected data processing models provided by the one or more model datastores 316. In addition, or alternatively, in some examples, the pipeline configuration parameters 314 may be preconfigured by one or more model datastores 316. For example, the pipeline configuration parameters 314 may define a data processing pipeline that is configured, hosted, and/or otherwise accessible through a model datastore 316.

In some embodiments, the execution workflow includes output parameters 320 that define one or more outputs of the execution workflow. The output parameters 320, for example, may define and/or identify at least one predictive output for one or more of the data processing pipelines of the execution workflow. In some examples, the predictive outputs may include unmodified (e.g., raw) outputs from the data processing pipelines of the execution workflow. For instance, the output parameters 320 may identify one or more predictive outputs (e.g., final outputs, intermediate outputs, etc.) generated by the one or more data processing pipelines and/or components (e.g., connected models, etc.) thereof.

In addition, or alternatively, the prediction outputs may include one or more post-processed outputs. For instance, the post-processed outputs the output parameters 320 may define and/or identify one or more classification criteria for classifying one or more outputs of the data processing pipelines. The classification criteria, for example, may include one or more output thresholds for assigning a classification to a time-dependent data object and/or group of time-dependent data objects. As an example, in a clinical prediction domain, an output threshold may include a score threshold for assigning a diagnosis based on a risk score output by a data processing pipeline.

In some examples, the output parameters 320 may establish one or more thresholds to extrapolate macro insights from granular predictive outputs from various data processing pipelines of an execution workflow. By way of example, the output parameters 320 may define one or more threshold combinations for assigning one or more output classifications based on a plurality of granular scores output by the data processing pipelines. In this manner, the output parameters 320 may simplify complex predictive scores to provide predictive insights that may be compared across a plurality of instances of an execution workflow to illustrate one or more data trends over time.

In some examples, the output parameters 320 may include one or more predetermined output parameters corresponding to a predefined output classifications. For instance, the output parameters 320 for an execution workflow may be selected from a list of predetermined output parameters, each respectively identifying a predefined output classification, score, and/or the like (and/or output type, such as unmodified, modified, etc.). In addition, or alternatively, the output parameters 320 may be generated to define an output (e.g., classification, score, etc.) tailored to a particular execution workflow.

In some embodiments, the execution workflow includes timing parameters 322 that define an execution frequency of the execution workflow. The timing parameters 322, for example, may define and/or identify a frequency, such as one or more hours, days, months, years, and/or the like, at which to execute an instance of the execution workflow. In some examples, the timing parameters 322 may include one or more predetermined timing parameters corresponding to one or more predefined time ranges. For instance, the timing parameters 322 for an execution workflow may be selected from a list of predetermined timing parameters, each respectively identifying a predefined time interval for executing an instance of the execution workflow. In addition, or alternatively, the timing parameters 322 may be generated to define a time interval tailored to a particular execution workflow.

In some embodiments, the execution workflow includes alert parameters 324 that define one or more alert triggers and/or alert recipients for an execution workflow. The one or more alert triggers, for example, may include one or more performance thresholds for identifying a performance anomaly. In some examples, the alert triggers may be configured to initiate the provision of an alert message in response to detecting that one or more predictive outputs exceed and/or fail to achieve the one or more performance thresholds. In addition, or alternatively, the one or more alert triggers may include one or more event triggers for identifying a trigger event, such as the completion of an instance of the execution workflow, and/or the like. In the event of a trigger event, the alert triggers may be configured to initiate the provision of an alert message to one or more alert recipients. The alert recipients may include one or more individuals, groups, and/or organizations. In some examples, the alert recipients may include one or more subscribers to a particular execution workflow.

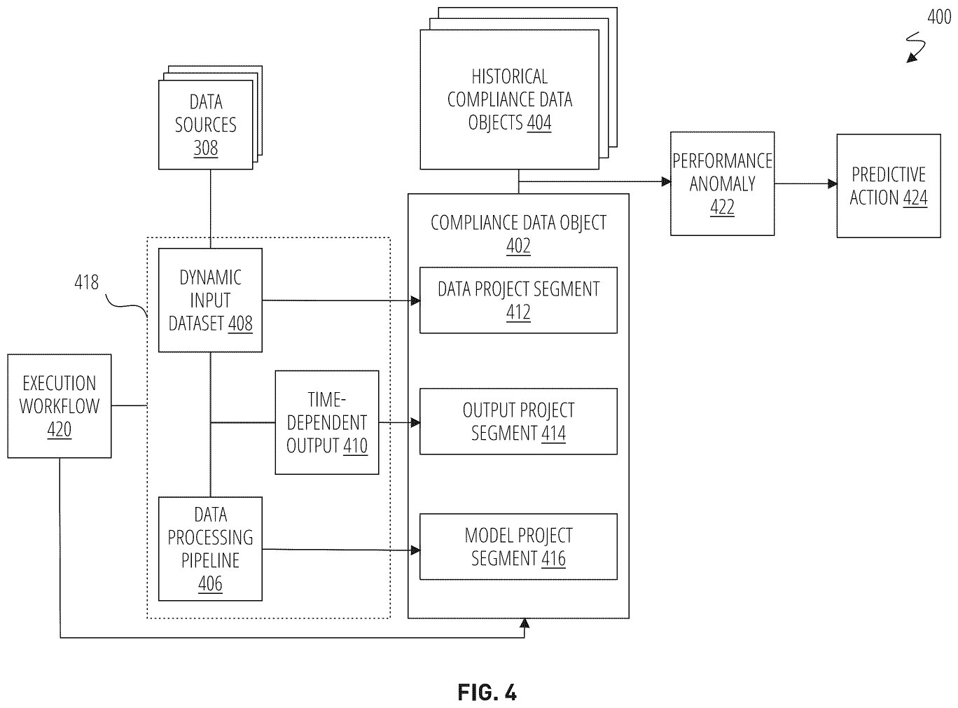

As described herein, the model development platform 306 may facilitate the development, maintenance, and/or execution of a plurality of execution workflows 420. Each of the execution workflows 420 may be executed at a defined frequency in accordance with one or more timing parameters 322 to monitor one or more aspects of a prediction domain. Such aspects may be monitored by analyzing data trends based on predictive insights generated by the execution workflows 312. Such trends, however, may be misleading due to the model complexities and the dynamic nature of the time-based data involved in an execution workflow. These technical difficulties have been traditionally addressed by maintaining partial records of the execution of an execution workflow that may maintain version histories of data processing pipelines and datasets in isolation. However, this is often insufficient to accurately re-execute a particular instance of an execution workflow. To address these difficulties, some embodiments of the present disclosure provide improved workflow tracking techniques by generating holistic compliance data objects that record every aspect of an instance of an execution workflow. These compliance data objects may be stored in a compliance datastore 302 and subsequently used to identify, monitor, and adjudicate anomalies of various types across the lifetime of an execution workflow. An example of an anomaly adjudication scheme will now further be described with reference to FIG. 4.

FIG. 4 is a dataflow diagram 400 showing example data structures for facilitating a complex execution workflow in accordance with some embodiments discussed herein. The dataflow diagram 400 illustrates a workflow instance 418 of an execution workflow 420 (e.g., an example execution workflow of the plurality of execution workflows 312 of FIG. 3). The workflow instance 418 may include data processing pipeline 406 that may be applied to a dynamic input dataset 408 (e.g., including data aggregated from one or more data sources 308) to generate the time-dependent outputs 410 at a particular point in time. In some examples, each of the components of the workflow instance 418 may be recorded by a compliance data object 402 to exactly reproduce the workflow instance 418 at a subsequent time-regardless of changes to the dynamic input dataset or the data processing pipeline subsequent to the execution of the workflow instance 418. Moreover, the compliance data object 402 may be compared against a plurality of historical compliance data objects 404 to detect one or more performance anomalies 422 and, in some examples, initiate a predictive action 424 to address the performance anomalies 422. In this manner, using some of the techniques of the present disclosure, an execution workflow 420 may be continuously executed, monitored, and tracked to proactively detect and address performance anomalies based on contextual information (e.g., model updates, data update, etc.) associated with a specific workflow instance (e.g., workflow instance 418).

In some embodiments, the workflow instance 418 is executed to generate the time-dependent outputs 410 at a current time. The current time may include a particular point in time that is based on one or more timing parameters of the execution workflow 420. For instance, the execution workflow 420 may include one or more timing parameters that may trigger the execution of the workflow instance 418 at the current time. The current time and the workflow instance 418 may be indicative of a most recent workflow instance 418, whereas the historical compliance data objects 404 may correspond to previous workflow instances that are executed at one or more historical times preceding the current time. For instance, the execution workflow 420 may include an execution frequency defined by the one or more timing parameters. The current time and/or the plurality of historical times may be based on the execution frequency. In some examples, some of the steps/operations described herein may be triggered at the current time based on the execution frequency.

In some embodiments, the time-dependent output 410 is generated at the current time for a current data version of the dynamic input dataset 408 using a current pipeline version of the data processing pipeline 406.

In some embodiments, the data processing pipeline 406 includes a plurality of connected data processing models. For instance, the connected data processing models may be arranged in a directed acyclic graph, as described herein. In some examples, the current pipeline version of the data processing pipeline 406 may be indicative of at least a current model version and/or a current set of weighted parameters for at least one of the plurality of connected data processing models. By way of example, the at least one connected data processing model may include a machine learning model and the current pipeline version may be indicative of a version of code for executing the machine learning model and/or a current set of weighted parameters for the machine learning model.

In some embodiments, a pipeline version of the data processing pipeline 406 is a data entity that describes the configuration of a data processing pipeline at a particular point in time. A pipeline version, for example, may include pipeline configuration data, such as the pipeline configuration parameters 314 of FIG. 3, for the data processing pipeline 406. In addition, or alternatively, the pipeline version may include model configuration data for each of the connected data processing models of the data processing pipeline 406.

As an example, the pipeline configuration data may be indicative of an arrangement of the connected data processing models (e.g., DAG record, etc.) at a particular point in time, one or more updates to the arrangement of the connected data processing models, and/or the like. In some examples, the model configuration data may be indicative of a model version for each of the plurality of connected data processing models. The model version, for example, may define a particular version of software code, and/or the like. In addition, or alternative, the model configuration data may be indicative of one or more weighted parameters (e.g., trained parameters for machine learning models, etc.) for one or more of the connected data processing models. By way of example, the pipeline configuration data may be indicative of a set of weighted parameters for each of the connected data processing models of the data processing pipeline at a particular point in time.

In some embodiments, at execution time, a current pipeline version is received to execute the latest version of the data processing pipeline 406 for the workflow instance 418. This may include receiving the current pipeline configuration data for the data processing pipeline 406 and/or the current model versions for each of the plurality of connected data processing models. As described herein, this data may be stored in the compliance data object 402 to provide context for the time-dependent outputs 410.

In some examples, the dynamic input dataset 408 may include a plurality of time-dependent data objects. The time-dependent data objects, for example, may be aggregated from the plurality of disparate data sources 308 based on the current time. For instance, the current data version of the dynamic input dataset 408 may be based on time-based priorities for the time-dependent objects. For example, a current data version of the dynamic input dataset 408 may include a subset of a plurality of time-dependent data objects that correspond to a current time window. By way of example, the time-based priority may be based on the current time window and one or more object attributes of the time-dependent data objects.

In some embodiments, a data version of a dynamic input dataset is a data entity that describes the configuration of a dynamic input dataset at a particular point in time. For example, a data version may include state data for the dynamic input dataset. The state data may be indicative of a particular version of the dataset that identifies the time-dependent data objects within the dynamic input dataset at a particular point in time. In addition, or alternatively, the state data may identify one or more time-based priorities, one or more updates, and/or the like for each of the time-dependent data objects of the dynamic input dataset at a particular point in time. In some examples, the time-dependent data objects of the dynamic input dataset at a particular point in time may include a plurality of data objects associated with a temporal attribute that is within a time window ending, beginning, and/or surrounding the particular point in time. In such a case, the state data for the dynamic input dataset may identify the time-dependent data objects (and/or the time-based priority, etc. thereof) that are associated with a temporal attribute that falls within the time window.

In some embodiments, at execution time, a current data version is received to process the latest version of the dynamic input dataset for the workflow instance 418. This may include receiving an updated plurality of time-dependent data objects (e.g., within a time range from the current time), updating one or more time-based priorities of the time-dependent data objects, and/or the like. As described herein, this data may be stored in the compliance data object 402 to provide context for the time-dependent outputs 410.

In some embodiments, a compliance data object 402 is generated that is indicative of the current pipeline version, the current data version, the time-dependent output 410, and/or any other information associated with the workflow instance 418. The compliance data object 402, for example, may include a current compliance data object that is configured to record one or more aspects of the workflow instance 418 at the current time.

In some embodiments, the compliance data object 402 is a data entity that describes an instance of an execution workflow 420 at a particular point in time. A compliance data object 402, for example, may include a plurality of project segments, each indicative of one or more aspects of a workflow instance 418 for the execution workflow 420 at a particular point in time. For example, a workflow instance 418 may include the execution of the data processing pipeline 406 on the dynamic input dataset 408 to generate the time-dependent outputs 410 at a particular point in time. The compliance data object 402 may include a model project segment 416 indicative of the data processing pipeline 406 at the particular point in time, a data project segment 412 indicative of the dynamic input dataset 408 at the particular point in time, and/or an output project segment 414 indicative of the time-dependent output 410 at the particular point in time. Each of the plurality of project segments may include version information for a respective aspect of the workflow instance 418 as well as metadata sufficient to re-execute the execution workflow 420 to receive the same time-dependent outputs 410 at a future time subsequent to the particular period of time at which the workflow instance 418 is initially executed.

In some embodiments, each project segment is indicative of a version and metadata for a particular aspect of the workflow instance 418. For example, a model project segment 416 may be indicative of a pipeline version and/or pipeline metadata for the pipeline version of the data processing pipeline 406. The pipeline metadata, for example, may be indicative of one or more execution anomalies (e.g., execution success/failure of one or more connected data processing models, etc.) related to the data processing pipeline 406, one or more execution metrics (e.g., time, processing power, etc.), one or more users (e.g., owners, developers, etc.), and/or the like. As another example, the data project segment 412 may be indicative of a data version and/or dataset metadata for the data version of the dynamic input dataset 408. The dataset metadata, for example, may be indicative of data configuration data (e.g., data sources, data structures, etc.) for the dynamic input dataset 408, one or more updates (e.g., update frequency, rate, extent, etc.) to the dynamic input dataset 408, one or more data anomalies (e.g., missing data exception, unbalanced dataset exceptions, etc.) related to the dynamic input dataset 408, one or more data metrics (e.g., data quality metrics, size metrics, bias metrics, etc.) for the dynamic input dataset 408, and/or the like.

As yet another example, the output project segment 414 may include the one or more time-dependent outputs 410. In some examples, the output project segment 414 may include project metadata that is indicative of one or more post processing thresholds (e.g., classification thresholds for classifying one or more objects of interest in data, etc.), one or more project anomalies (e.g., trends, output outliers, etc. based on previous workflow instances, etc.), and/or the like.

In some embodiments, one or more performance anomalies 422 are identified based on a comparison between the compliance data object 402 and a plurality of historical compliance data objects 404. The plurality of historical compliance data objects 404, for example, may correspond to a plurality of historical times that temporally precede the current time. For instance, the historical compliance data objects 404 may record one or more aspects for a plurality of historical workflow instances that precede the workflow instance 418. The performance anomalies 422 may be indicative of one or more discrepancies between the compliance data object 402 for the workflow instance 418 and/or one or more of the historical compliance data objects 404 for the previous workflow instances.

By way of example, each of the historical compliance data objects 404 may correspond to a historical time. In some examples, a respective historical compliance data object may be indicative of a historical pipeline version of the data processing pipeline 406 at the historical time, a historical data version of the dynamic input dataset 408 at the historical time, and/or a historical time-dependent output previously generated for the historical data version of the dynamic input dataset 408 using the historical pipeline version of the data processing pipeline 406. In some examples, the performance anomaly 422 may be based on a comparison between the time-dependent output 410, one or more historical time-dependent outputs, and/or an anomaly threshold.

In some embodiments, the performance anomaly 422 may be a data entity that describes an anomalous output from the workflow instance 418. The anomalous output may be based on a comparison between a time-dependent output from the workflow instance 418 and a plurality of historical workflow instances. For example, the performance anomaly 422 may be indicative of one or more outlier time-dependent outputs relative to historical outputs from the data processing pipeline 406.

In some embodiments, a project segment of the execution workflow 420 is identified that corresponds to the performance anomalies 422. The project segment, for example, may be indicative of at least one of the current pipeline version, the current data version, and/or the time-dependent outputs 410. In some examples, the project segment may identify at least one of a model-based anomaly and/or a data-based anomaly. The model-based anomaly, for example, may be based on a comparison between a historical pipeline version of the historical compliance data objects 404 and the current pipeline version of the compliance data object 402. The data-based anomaly may be based on a comparison between a historical data version of the historical compliance data objects 404 and a current date version of the compliance data object 402.

In some embodiments, a model-based anomaly may be a data entity that describes a predictive contributor to a performance anomaly 422. A model-based anomaly, for example, may be a prediction that the data processing pipeline 406 contributed to the performance anomaly 422. By way of example, the model-based anomaly may be indicative of one or more predictive model errors (e.g., development, runtime, etc.), modifications, and/or the like that have a predictive impact on the time-dependent outputs 410 of the data processing pipeline 406.

In some embodiments, a data-based anomaly is a data entity that describes a predictive contributor to a performance anomaly 422. A data-based anomaly, for example, may include a prediction that the dynamic input dataset 408 contributed to the performance anomaly 422. By way of example, the data-based anomaly may be indicative of one or more predictive data errors (e.g., aggregation errors, data query errors, incomplete data entries, etc.), modifications, and/or the like, that have a predictive impact on the time-dependent outputs 410 of the data processing pipeline 406.

In some embodiments, the performance of a predictive action 424 is initiated based on the performance anomaly 422. In some embodiments, a predictive action 424 is a data entity that describes an action for responding to a performance anomaly 422. A predictive action 424 may include a corrective action and/or an alerting action. For instance, a corrective action may include one or more predictive corrections for modifying the data processing pipeline 406 and/or the dynamic input dataset 408 to correct a model-based and/or data-based anomaly. As another example, an alerting action may include generating and/or providing one or more predictive alert messages to one or more computing systems (and/or users thereof) to record and/or notify a recipient of the message. An alerting action, for example, may be based on one or more alert parameters of the execution workflow 420.

In some embodiments, the performance of a predictive action 424 is initiated based on the project segment associated with the performance anomaly 422. For example, in response to a model-based anomaly, the pipeline segment may be indicative of the current pipeline version and the predictive action 424 may include initiating the presentation of a model interface for modifying one or more parameters for the data processing pipeline 406 (e.g., pipeline parameters, model parameters, etc.). As another example, in response to a data-based anomaly, the pipeline segment may be indicative of the current data version and the predictive action 424 may include initiating the presentation of a model interface for modifying one or more parameters for the dynamic input dataset 408.

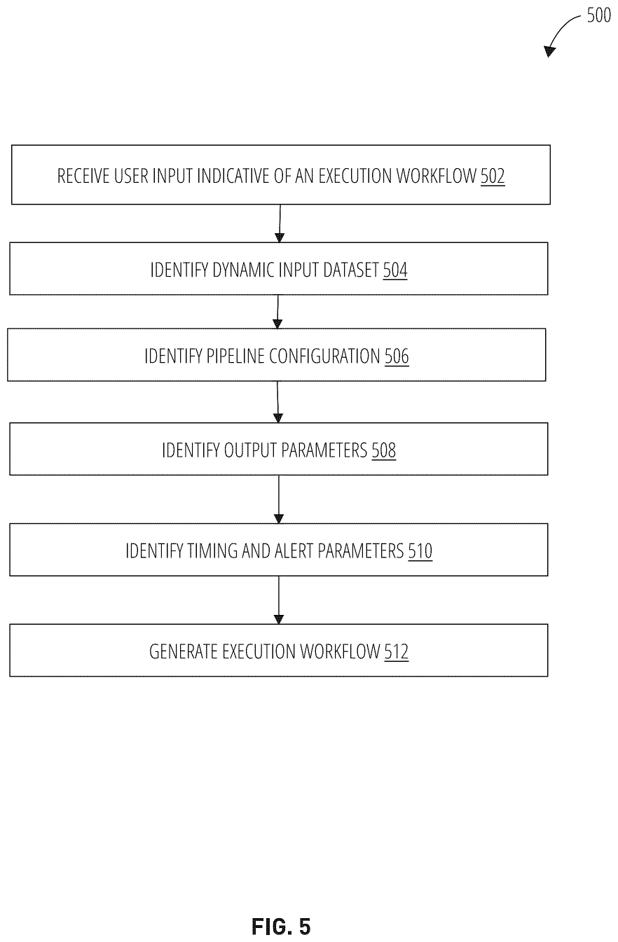

FIG. 5 is a flowchart showing an example of a process 500 for generating an execution workflow in accordance with some embodiments discussed herein. The flowchart depicts model development techniques for generating complex data processing workflows for monitoring temporal data trends over time. The model development techniques enable the generation of holistic execution workflows that seamlessly account for modifications to complex data processing models (and/or one or more components thereof) and dynamic input datasets to overcome various limitations of traditional development environments. The model development techniques may be implemented by one or more computing devices, entities, and/or systems described herein. For example, via the various steps/operations of the process 500, the computing system 100 may leverage the model development techniques to overcome the various limitations with traditional development environments by defining a unique combination of parameters to initiate specific, traceable data processing tasks at regular intervals to establish comprehensive execution histories for holistically evaluating complex predictive outputs that are traditionally uninterpretable.

FIG. 5 illustrates an example process 500 for explanatory purposes. Although the example process 500 depicts a particular sequence of steps/operations, the sequence may be altered without departing from the scope of the present disclosure. For example, some of the steps/operations depicted may be performed in parallel or in a different sequence that does not materially impact the function of the process 500. In other examples, different components of an example device or system that implements the process 500 may perform functions at substantially the same time or in a specific sequence.

In some embodiments, the process 500 includes, at step/operation 502, receiving a user input indicative of an execution workflow. For example, the computing system 100 may receive the user input. The user input may be indicative of one or more workflow parameters, such as a workflow name, one or more collaborators, a textual description, and/or the like.

In some embodiments, the process 500 includes, at step/operation 504, identifying a dynamic input dataset. For example, the computing system 100 may identify the dynamic input dataset based on one or more dataset parameters. In some examples, the dataset parameters may be identified based on user input from one or more collaborators for the execution workflow. For instance, the user input may be indicative of a selection of one or more predefined dataset parameters. In addition, or alternatively, the user input may be indicative of one or more dynamically defined dataset parameters.

In some embodiments, the process 500 includes, at step/operation 506, identifying a pipeline configuration. For example, the computing system 100 may identify the pipeline configuration based on one or more pipeline configuration parameters. In some examples, the pipeline configuration parameters may be identified based on user input from one or more collaborators for the execution workflow. For instance, the user input may be indicative of a selection of one or more predefined pipeline configuration parameters indicative of a preconfigured data processing pipeline. In addition, or alternatively, the user input may be indicative of one or more dynamically defined pipeline configuration parameters. By way of example, the user input may be indicative of the selection of one or more connected data processing models and/or a sequence for executing the one or more connected data processing models.

In some embodiments, the process 500 includes, at step/operation 508, identifying one or more output parameters. For example, the computing system 100 may identify one or more output parameters. In some examples, the output parameters may be identified based on user input from one or more collaborators for the execution workflow. For instance, the user input may be indicative of a selection of one or more predefined output parameters indicative of one or more preconfigured output types. In addition, or alternatively, the user input may be indicative of one or more dynamically defined output parameters. By way of example, the user input may be indicative of the selection of one or more output types, post processing thresholds, classification criteria, and/or the like.

In some embodiments, the process 500 includes, at step/operation 510, identifying one or more timing and/or alert parameters. For example, the computing system 100 may identify one or more timing and/or alert parameters. In some examples, the timing and/or alert parameters may be identified based on user input from one or more collaborators for the execution workflow. For instance, the user input may be indicative of a selection of one or more predefined timing and/or alert parameters indicative of one or more preconfigured frequency and/or alert types.

In some embodiments, the process 500 includes, at step/operation 512, generating the execution workflow. For example, the computing system 100 may generate the execution workflow based on the dynamic input dataset defined by one or more selected and/or input dataset parameters, a data processing pipeline defined by the pipeline configuration, the output parameters, and/or the timing/alert parameters.

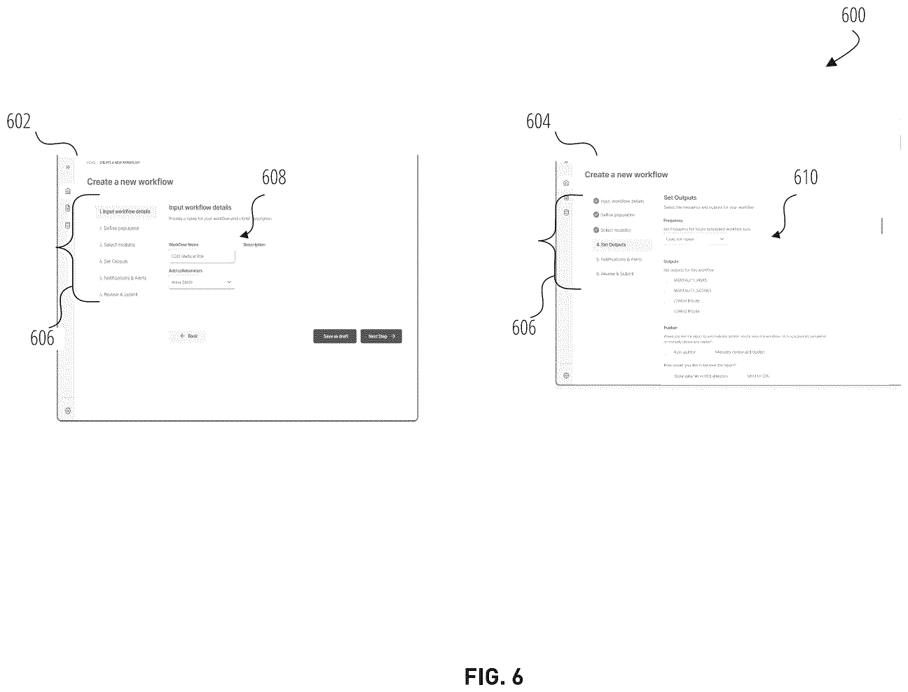

FIG. 6 is an operational example 600 of configuration interfaces in accordance with some embodiments discussed herein. The operational example 600 illustrates two example interfaces for a user-facing workflow configuration process. The first example configuration user interface 602 may include a project start-up page. The start-up page may include one or more interactive widgets 608 for receiving one or more workflow parameters, such as a workflow name, one or more collaborators, a textual description, and/or the like. The second example configuration user interface 604 may include an output selection page. The output selection page may include one or more interactive widgets 610 for receiving one or more output parameters.

In some examples, the first example configuration user interface 602 and the second example configuration user interface 604 may include a plurality of interactive icons 606 identifying each stage of the workflow configuration process. The interactive icons 606, for example, may identify the start-up page, a data definition page, a model selection page, an output selection page, a notification and alerts page, a submission page, and/or the like. In some examples, the interactive icons 606 may identify a performance status for each stage of the workflow configuration process. By way of example, in the first example configuration user interface 602, the status for each of the stages of the workflow configuration process may be incomplete, whereas in a second example, configuration user interface 604, the status for the start-up, a data definition, a model selection stages may be completed.

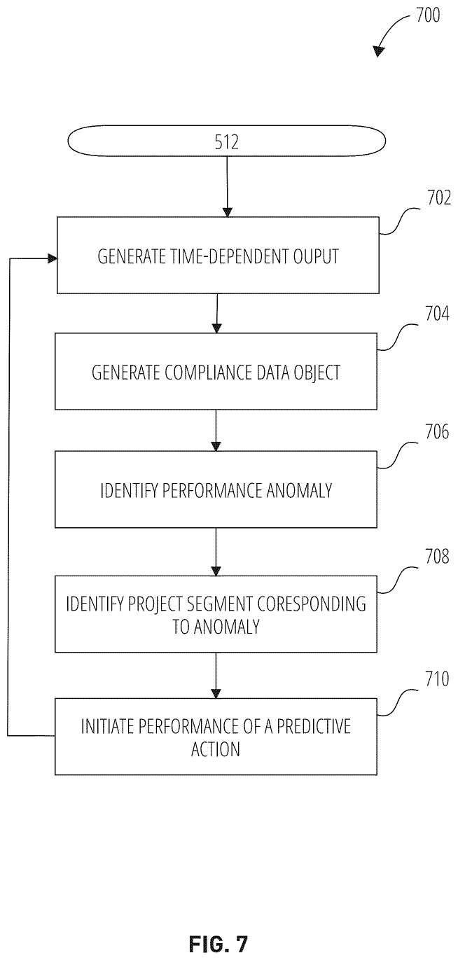

FIG. 7 is a flowchart showing an example of a process for executing an execution workflow in accordance with some embodiments discussed herein. The flowchart depicts data processing and tracking techniques for monitoring data trends, detecting anomalies, and tracing anomalies to their respective sources. The data processing and tracking techniques may be implemented by one or more computing devices, entities, and/or systems described herein. For example, via the various steps/operations of the process 700, the computing system 100 may leverage the data processing and tracking techniques to overcome the various limitations with traditional complex project workspaces by generating and leveraging a historical record of comprehensive compliance data objects that may individually track each of a plurality of components in a multi-faceted execution workflow.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence. In some examples, the process 700 may include a plurality of operations subsequent to step/operation 512 in which the process 500 generates an execution workflow.

In some embodiments, the process 700 includes, at step/operation 702, generating a time-dependent output. For example, the computing system 100 may generate, using a current pipeline version of a data processing pipeline, a time-dependent output for a current data version of a dynamic input dataset at a current time.

In some examples, the current data version of the dynamic input dataset may be based on a time-based priority for one or more time-dependent data objects. For example, the current data version may include a subset of a plurality of time-dependent data objects that correspond to a current time window. In some examples, the time-based priority may be based on the current time window and/or one or more object attributes of the time-dependent data object. In some embodiments, the plurality of time-dependent data objects are aggregated from a plurality of disparate data sources.

In some examples, the data processing pipeline includes a plurality of connected data processing models arranged in a directed acyclic graph. The current pipeline version, for example, may be indicative of at least a current model version and a current set of weighted parameters for at least one of the plurality of connected data processing models. In some examples, at least one of the plurality of connected data processing models includes a machine learning model.

In some embodiments, the process 700 includes, at step/operation 704, generating a compliance data object. For example, the computing system 100 may generate a current compliance data object that is indicative of the current pipeline version, the current data version, and/or the time-dependent output.

In some embodiments, the process 700 includes, at step/operation 706, identifying a performance anomaly. For example, the computing system 100 may identify the performance anomaly based on a comparison between the current compliance data object and a plurality of historical compliance data objects.

The plurality of historical compliance data objects may correspond to a plurality of historical times temporally preceding the current time. In some examples, the historical compliance data object of the plurality of historical compliance data objects corresponds to a historical time of the plurality of historical times. For example, the historical compliance data object may be indicative of a historical pipeline version of the data processing pipeline at the historical time, a historical data version of the dynamic input dataset at the historical time, and/or a historical time-dependent output previously generated for the historical data version of the dynamic input dataset using the historical pipeline version of the data processing pipeline.

In some examples, the data processing pipeline may be associated with an execution workflow that includes an execution frequency. In such a case, the current time and the plurality of historical times may be based on the execution frequency.

In some embodiments, the performance anomaly is based on a comparison between the time-dependent output, the historical time-dependent output, and/or an anomaly threshold.

In some embodiments, the process 700 includes, at step/operation 708, identifying a project segment corresponding to the anomaly. For example, the computing system 100 may identify the project segment corresponding to the anomaly. The project segment may be indicative of at least one of the current pipeline version, the current data version, or the time-dependent output. In some examples, the computing system 100 may identify the project segment corresponding to the performance anomaly by identifying at least one of (i) a model-based anomaly based on a comparison between the historical pipeline version and the current pipeline version and/or (ii) a data-based anomaly based on a comparison between the historical data version and the current data version.

In some embodiments, the process 700 includes, at step/operation 710, initiating performance of a predictive action. For example, the computing system 100 may initiate the performance of a predictive action based on the project segment. In the event that a model-based anomaly is identified, the project segment may be indicative of the current pipeline version, and the predictive action may include initiating the presentation of a model interface for modifying one or more model parameters for the data processing pipeline. In the event that a data-based anomaly is identified, the project segment is indicative of the current data version, and the predictive action may include initiating the presentation of a data interface for modifying one or more data parameters for the dynamic input dataset.

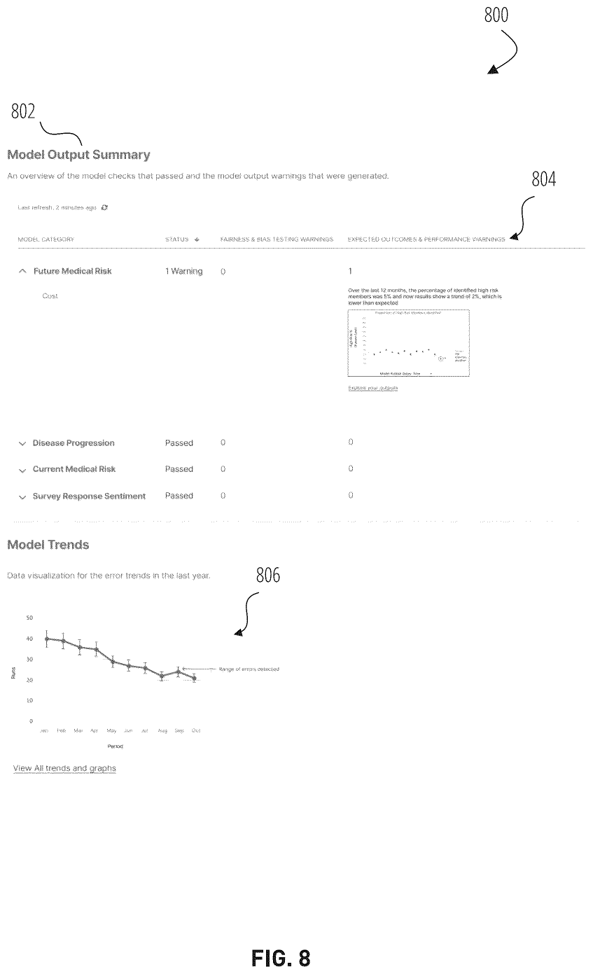

FIG. 8 is an operational example 800 of an execution report interface in accordance with some embodiments discussed herein. The operational example 800 illustrates an execution report interface 802 for a user-facing data anomaly detection and handling process. The execution report interface 802 may include one or more execution results for a plurality of data processing pipelines, such a future medical risk pipeline, a disease progression pipeline, a current medical risk pipeline, a survey response sentiment pipeline, and/or the like in a clinical predictive domain. In some examples, the execution report interface 802 may include an interactive performance anomaly icon 804 indicative of one or more performance anomalies for a respective data processing pipeline. For example, the interactive performance anomaly icon 804 may be indicative of a performance anomaly with a future medical risk pipeline. The performance anomaly may identify an irregularity with the time-dependent outputs from the future medical risk pipeline compared to previous executions of the pipeline. For example, for the clinical prediction domain, the performance anomaly may indicate a lower trend of high-risk members compared to previous predictions (e.g., over a 12-month span).

In some examples, the execution report interface 802 may identify a project segment and/or one or more trends associated therewith. For example, the execution report interface 802 may include a project segment icon 806 indicative of one or more current and/or historical trends associated with a project segment. In some examples, the project segment icon 806 may be provided in response to the performance anomaly. For instance, the project segment icon 806 may be based on a model-based anomaly for interpreting the performance anomaly. In this manner, the execution report interface 802 may provide a holistic workflow data anomaly detection and handling interface in which a performance anomaly may be detected, traced back to the source, and handled at the source. This, in turn, allows for improved data prediction and interpretability of complex data processing results over time.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A computer-implemented method, the computer-implemented method comprising generating, by one or more processors and using a current pipeline version of a data processing pipeline, a time-dependent output for a current data version of a dynamic input dataset at a current time; generating, by the one or more processors, a current compliance data object that is indicative of the current pipeline version, the current data version, and the time-dependent output; identifying, by the one or more processors, a performance anomaly based on a comparison between the current compliance data object and a plurality of historical compliance data objects, wherein the plurality of historical compliance data objects corresponds to a plurality of historical times temporally preceding the current time; identifying, by the one or more processors, a project segment corresponding to the performance anomaly, wherein the project segment is indicative of at least one of the current pipeline version, the current data version, or the time-dependent output; and initiating, by the one or more processors, the performance of a predictive action based on the project segment.

Example 2. The computer-implemented method of example 1, wherein the current data version of the dynamic input dataset based on a time-based priority for one or more time-dependent data objects.

Example 3. The computer-implemented method of example 2, wherein (i) the current data version comprises a subset of a plurality of time-dependent data objects that correspond to a current time window, and (ii) the time-based priority is based on the current time window and one or more object attributes of the plurality of time-dependent data objects.

Example 4. The computer-implemented method of example 3, wherein the plurality of time-dependent data objects are aggregated from a plurality of disparate data sources.

Example 5. The computer-implemented method of any of examples 1 through 4, wherein (i) the data processing pipeline comprises a plurality of connected data processing models arranged in a directed acyclic graph, and (ii) the current pipeline version is indicative of at least a current model version and a current set of weighted parameters for at least one of the plurality of connected data processing models.

Example 6. The computer-implemented method of example 5, wherein at least one of the plurality of connected data processing models comprises a machine learning model.

Example 7. The computer-implemented method of any of examples 1 through 6, wherein (i) a historical compliance data object of the plurality of historical compliance data objects corresponds to a historical time of the plurality of historical times, and (ii) the historical compliance data object is indicative of (a) a historical pipeline version of the data processing pipeline at the historical time, (b) a historical data version of the dynamic input dataset at the historical time, and (c) a historical time-dependent output previously generated for the historical data version of the dynamic input dataset using the historical pipeline version of the data processing pipeline.

Example 8. The computer-implemented method of example 7, wherein the performance anomaly is based on a comparison between the time-dependent output, the historical time-dependent output, and an anomaly threshold.

Example 9. The computer-implemented method of example 8, wherein identifying the project segment corresponding to the performance anomaly comprises identifying at least one of (i) a model-based anomaly based on a comparison between the historical pipeline version and the current pipeline version, or (ii) a data-based anomaly based on a comparison between the historical data version and the current data version.

Example 10. The computer-implemented method of example 9, wherein the model-based anomaly is identified, the project segment is indicative of the current pipeline version, and the predictive action comprises initiating the presentation of a model interface for modifying one or more model parameters for the data processing pipeline.

Example 11. The computer-implemented method of examples 9 or 10, wherein the data-based anomaly is identified, the project segment is indicative of the current data version, and the predictive action comprises initiating the presentation of a data interface for modifying one or more data parameters for the dynamic input dataset.

Example 12. The computer-implemented method of any of the preceding examples, wherein (i) the data processing pipeline is associated with an execution workflow comprising an execution frequency, and (ii) the current time and the plurality of historical times are based on the execution frequency.

Example 13. A system comprising memory and one or more processors communicatively coupled to the memory, the one or more processors configured to generate, using a current pipeline version of a data processing pipeline, a time-dependent output for a current data version of a dynamic input dataset at a current time; generate a current compliance data object that is indicative of the current pipeline version, the current data version, and the time-dependent output; identify a performance anomaly based on a comparison between the current compliance data object and a plurality of historical compliance data objects, wherein the plurality of historical compliance data objects corresponds to a plurality of historical times temporally preceding the current time; identify a project segment corresponding to the performance anomaly, wherein the project segment is indicative of at least one of the current pipeline version, the current data version, or the time-dependent output; and initiate the performance of a predictive action based on the project segment.

Example 14. The system of example 13, wherein the current data version of the dynamic input dataset based on a time-based priority for one or more time-dependent data objects.

Example 15. The system of example 14, wherein (i) the current data version comprises a subset of a plurality of time-dependent data objects that correspond to a current time window, and (ii) the time-based priority is based on the current time window and one or more object attributes of the plurality of time-dependent data objects.

Example 16. The system of example 15, wherein the plurality of time-dependent data objects are aggregated from a plurality of disparate data sources.

Example 17. The system of any of examples 13 through 16, wherein (i) the data processing pipeline comprises a plurality of connected data processing models arranged in a directed acyclic graph, and (ii) the current pipeline version is indicative of at least a current model version and a current set of weighted parameters for at least one of the plurality of connected data processing models.

Example 18. The system of example 17, wherein at least one of the plurality of connected data processing models comprises a machine learning model.

Example 19. The system of any of examples 13 through 18, wherein (i) a historical compliance data object of the plurality of historical compliance data objects corresponds to a historical time of the plurality of historical times, and (ii) the historical compliance data object is indicative of (a) a historical pipeline version of the data processing pipeline at the historical time, (b) a historical data version of the dynamic input dataset at the historical time, and (c) a historical time-dependent output previously generated for the historical data version of the dynamic input dataset using the historical pipeline version of the data processing pipeline.

Example 20. One or more non-transitory computer-readable storage media including instructions that, when executed by one or more processors, cause the one or more processors to generate, using a current pipeline version of a data processing pipeline, a time-dependent output for a current data version of a dynamic input dataset at a current time; generate a current compliance data object that is indicative of the current pipeline version, the current data version, and the time-dependent output; identify a performance anomaly based on a comparison between the current compliance data object and a plurality of historical compliance data objects, wherein the plurality of historical compliance data objects corresponds to a plurality of historical times temporally preceding the current time; identify a project segment corresponding to the performance anomaly, wherein the project segment is indicative of at least one of the current pipeline version, the current data version, or the time-dependent output; and initiate the performance of a predictive action based on the project segment.

1. A computer-implemented method, the computer-implemented method comprising:
generating, by one or more processors and using a current pipeline version of a data processing pipeline, a time-dependent output for a current data version of a dynamic input dataset at a current time;
generating, by the one or more processors, a current compliance data object that is indicative of the current pipeline version, the current data version, and the time-dependent output;
identifying, by the one or more processors, a performance anomaly based on a comparison between the current compliance data object and a plurality of historical compliance data objects, wherein the plurality of historical compliance data objects corresponds to a plurality of historical times temporally preceding the current time;
identifying, by the one or more processors, a project segment corresponding to the performance anomaly, wherein the project segment is indicative of at least one of the current pipeline version, the current data version, or the time-dependent output; and
initiating, by the one or more processors, the performance of a predictive action based on the project segment.

2. The computer-implemented method of claim 1, wherein the current data version of the dynamic input dataset based on a time-based priority for one or more time-dependent data objects.

3. The computer-implemented method of claim 2, wherein:
(i) the current data version comprises a subset of a plurality of time-dependent data objects that correspond to a current time window, and
(ii) the time-based priority is based on the current time window and one or more object attributes of the plurality of time-dependent data objects.

4. The computer-implemented method of claim 3, wherein the plurality of time-dependent data objects are aggregated from a plurality of disparate data sources.

5. The computer-implemented method of claim 1, wherein:
(i) the data processing pipeline comprises a plurality of connected data processing models arranged in a directed acyclic graph, and
(ii) the current pipeline version is indicative of at least a current model version and a current set of weighted parameters for at least one of the plurality of connected data processing models.

6. The computer-implemented method of claim 5, wherein at least one of the plurality of connected data processing models comprises a machine learning model.

7. The computer-implemented method of claim 1, wherein:
(i) a historical compliance data object of the plurality of historical compliance data objects corresponds to a historical time of the plurality of historical times, and
(ii) the historical compliance data object is indicative of:
(a) a historical pipeline version of the data processing pipeline at the historical time,
(b) a historical data version of the dynamic input dataset at the historical time, and
(c) a historical time-dependent output previously generated for the historical data version of the dynamic input dataset using the historical pipeline version of the data processing pipeline.

8. The computer-implemented method of claim 7, wherein the performance anomaly is based on a comparison between the time-dependent output, the historical time-dependent output, and an anomaly threshold.

9. The computer-implemented method of claim 8, wherein identifying the project segment corresponding to the performance anomaly comprises:
identifying at least one of (i) a model-based anomaly based on a comparison between the historical pipeline version and the current pipeline version, or (ii) a data-based anomaly based on a comparison between the historical data version and the current data version.

10. The computer-implemented method of claim 9, wherein the model-based anomaly is identified, the project segment is indicative of the current pipeline version, and the predictive action comprises:
initiating the presentation of a model interface for modifying one or more model parameters for the data processing pipeline.

11. The computer-implemented method of claim 9, wherein the data-based anomaly is identified, the project segment is indicative of the current data version, and the predictive action comprises:
initiating the presentation of a data interface for modifying one or more data parameters for the dynamic input dataset.

12. The computer-implemented method of claim 1, wherein:
(i) the data processing pipeline is associated with an execution workflow comprising an execution frequency, and
(ii) the current time and the plurality of historical times are based on the execution frequency.

13. A system comprising memory and one or more processors communicatively coupled to the memory, the one or more processors configured to:
generate, using a current pipeline version of a data processing pipeline, a time-dependent output for a current data version of a dynamic input dataset at a current time;
generate a current compliance data object that is indicative of the current pipeline version, the current data version, and the time-dependent output;
identify a performance anomaly based on a comparison between the current compliance data object and a plurality of historical compliance data objects, wherein the plurality of historical compliance data objects corresponds to a plurality of historical times temporally preceding the current time;
identify a project segment corresponding to the performance anomaly, wherein the project segment is indicative of at least one of the current pipeline version, the current data version, or the time-dependent output; and
initiate the performance of a predictive action based on the project segment.

14. The system of claim 13, wherein the current data version of the dynamic input dataset based on a time-based priority for one or more time-dependent data objects.

15. The system of claim 14, wherein:
(i) the current data version comprises a subset of a plurality of time-dependent data objects that correspond to a current time window, and
(ii) the time-based priority is based on the current time window and one or more object attributes of the plurality of time-dependent data objects.

16. The system of claim 15, wherein the plurality of time-dependent data objects are aggregated from a plurality of disparate data sources.

17. The system of claim 13, wherein:
(i) the data processing pipeline comprises a plurality of connected data processing models arranged in a directed acyclic graph, and
(ii) the current pipeline version is indicative of at least a current model version and a current set of weighted parameters for at least one of the plurality of connected data processing models.

18. The system of claim 17, wherein at least one of the plurality of connected data processing models comprises a machine learning model.

19. The system of claim 13, wherein:
(i) a historical compliance data object of the plurality of historical compliance data objects corresponds to a historical time of the plurality of historical times, and
(ii) the historical compliance data object is indicative of:
(a) a historical pipeline version of the data processing pipeline at the historical time,
(b) a historical data version of the dynamic input dataset at the historical time, and
(c) a historical time-dependent output previously generated for the historical data version of the dynamic input dataset using the historical pipeline version of the data processing pipeline.

20. One or more non-transitory computer-readable storage media including instructions that, when executed by one or more processors, cause the one or more processors to:
generate, using a current pipeline version of a data processing pipeline, a time-dependent output for a current data version of a dynamic input dataset at a current time;
generate a current compliance data object that is indicative of the current pipeline version, the current data version, and the time-dependent output;
identify a performance anomaly based on a comparison between the current compliance data object and a plurality of historical compliance data objects, wherein the plurality of historical compliance data objects corresponds to a plurality of historical times temporally preceding the current time;
identify a project segment corresponding to the performance anomaly, wherein the project segment is indicative of at least one of the current pipeline version, the current data version, or the time-dependent output; and
initiate the performance of a predictive action based on the project segment.
